(19) United States
(12) Patent Application Publication
(10) Pub. No.: US 2007/0175122 A1
(43) Pub. Date: Aug. 2, 2007

(54) Device for vertically adjusting the jamb of a hollow door frame

(76) Inventor: Bruce J. Bennett, Niagara Falls, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/325,298

(22) Filed: Jan. 4, 2006

(51) Int. Cl. E06B 1/04

(52) U.S. Cl. 52/211

(57) ABSTRACT

This invention provides an improved device for permitting vertical adjustment of the jamb (11) of a hollow door frame that is adapted to be attached to supporting structure. The improved device includes: a member (28) attached to the jamb, said member having at least one tapped hole; and a threaded member (24) matingly received in the tapped hole, the threaded member having a head portion adapted to engage the floor; and wherein the threaded member may be selectively rotated relative to the member to vary the vertical position of said jamb relative to said floor.

### TECHNICAL FIELD

The present invention relates generally to hollow door frames, such as are commonly used in commercial construction, and, more particularly, to improved devices for holding and for vertically positioning a jamb relative to the floor, either when the jamb is initially installed or when it is subsequently adjusted.

### BACKGROUND ART

In construction, notably in commercial construction, hollow door frames are mounted on a rough-framed wall. These door frames are typically formed of metal, and have an integrally-formed stop therein. The door frames are then used to encompass marginal portions of the rough-framed structure.

In a typical installation, the door frame has a horizontal header, and two vertical jambs. There may possibly be a spreader at the lower marginal ends of the jambs. The jambs typically support the header. In a conventional installation, the portions of the door frame are suitably attached, as by the use of drywall screws and the like, from the rough-framed structure.

Once such door frames are initially installed, the carpenter will typically plumb the jambs to insure that they are vertical prior to attaching them to the supporting structure. However, buildings settle, and such frames are subject to vibration and abuse. Thus, whereas the jambs may have initially been plumb, through usage and over passage of time, it is common for the frame to become distorted. When this occurs, it is necessary to adjust the door frame relative to the roughed opening.

It is not practical to simply remove the drywall screws from the frame, and to adjust the position of the jamb, and then reinstall the drywall screws in the same holes. In many cases, the jamb is moved only slightly relative to the frame. Moreover, one would like to minimize the number of holes or penetrations in the hollow door frame itself.

At the same time, there is a need for the capability of quickly adjusting the vertical position of a door jamb relative to the floor to hasten the adjustment of the door frame. With union carpenters costing on the order of $55 per hour in a large commercial building, such as a hotel, it is critical to minimize the amount of time that the carpenter must spend in adjusting each door frame.

### DISCLOSURE OF THE INVENTION

With parenthetical reference to the corresponding parts, portions or surfaces of the disclosed embodiments, merely for purposes of illustration and not by way of limitation, the present invention broadly provides improved devices (28, 35) for adjusting the vertical position of the jamb (10) of a hollow door frame relative to the floor.

In one aspect, the improved device includes: a clip (28) adapted to be selectively attached to the jamb, the clip having at least one tapped hole; and a threaded member (34) matingly received in the tapped hole, the threaded member having a head portion adapted to engage the floor, and wherein the threaded member may be selectively rotated relative to the clip to vary the vertical position of the jamb relative to the floor.

The clip may be removably attached to the jamb. The clip may have a recess (33) adapted to embrace a portion, such as a lower marginal end portion, of the jamb. This recess may frictionally engage the jamb portion.

In one form, the clip includes a channel-shaped portion having a web and two parallel flanges, and wherein aligned tapped holes are provided in the flanges to receive and accommodate the threaded member. The threaded member may be a bolt.

In another aspect, the improved device includes: a member (35) attached to the jamb, the member having at least one tapped hole; and a threaded member (34) matingly received in the tapped hole, the threaded member having a head portion adapted to engage the floor; and wherein the threaded member may be selectively rotated relative to the clip to vary the vertical position of the jamb relative to the floor.

The member may be permanently attached to the jamb, as by welding. The member may be a channel-shaped member having a web and two parallel flanges, and wherein the flanges are provided with aligned tapped holes to receive and accommodate the threaded member. The threaded member may be a bolt.

Accordingly, the general object of the invention is to provide an improved device for allowing the vertical position of a jamb to be adjusted relative to the floor, either when initially installed or thereafter.

Since another object is to provide an improved device that may be retrofitted on existing doors, to allow their vertical position to be adjusted relative to the floor.

Still another object is to provide an improved device that allows a doorjamb to be vertically adjusted relative to the floor, and that allows such adjustment to be made with a minimum of time and expense.

These and other objects and advantages will become apparent from the foregoing and ongoing written specification, the drawings, and the appended claims.

### BRIEF DESCRIPTION OF THE DRAWINGS

FIG. 1 is a fragmentary horizontal sectional view of a hollow metal door frame mounted on the supporting structure of a roughed-in opening, and showing the removable clip in association with the jamb.

FIG. 2 is a fragmentary transverse vertical sectional view thereof, taken generally on line 2-2 of FIG. 1, showing the clip as being removably mounted on, and frictionally engaging, the lower marginal end portion of the jamb, and further showing the bolt as engaging the floor.

FIG. 3 is a fragmentary horizontal sectional view of another form, showing a clip as being permanently attached, as by welding, to the interior of the jamb.

FIG. 4 is a fragmentary transverse vertical sectional view thereof, taken generally on line 4-4 of FIG. 3, showing the channel-shaped clip as being permanently secured to the inside surface of the door jamb.

### DESCRIBED OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

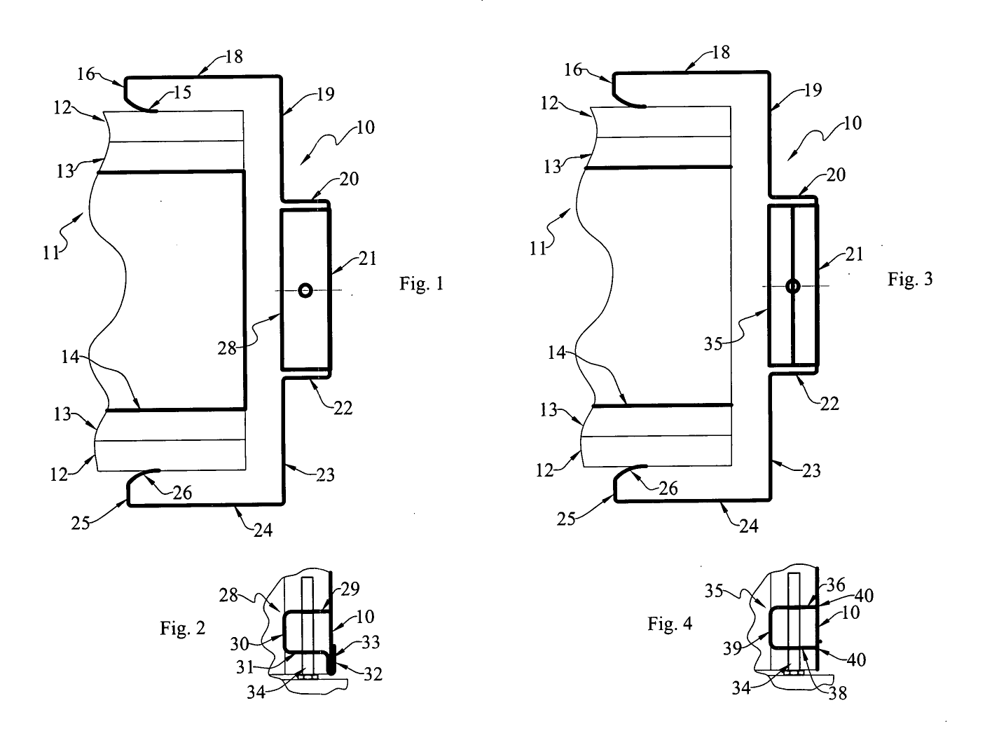

Referring now to the drawings, the present invention provides an improved device for selectively allowing the vertical adjustment of the jamb of a hollow door frame relative to the floor. A first form of the improved device is shown in FIGS. 1 and 2, and a second form is shown in FIGS. 3 and 4.

First Form (FIGS. 1-2)

Referring now to FIGS. 1 and 2, the jamb 10 of a hollow door frame is adapted to be attached to supporting structure, generally indicated at 11. This supporting structure is shown as including double thicknesses of drywall 12, 13, and a C-shaped metal stud 14. In this particular case, the jamb is shown as being a specially-configured vertically-elongated bent-metal member having, from top-to-bottom in FIG. 2, an in-turned marginal end portion 15, a vertical portion 16, a horizontal portion 18, a vertical portion 19, a rightwardly-extending portion 20, a downwardly-extending portion 21, a leftwardly-extending portion 22, a downwardly-extending portion 23, a leftwardly-extending portion 24, an upwardly-extending portion 25, and another in turned portion 26. Portions 20, 21 and 22 form an integral stop in the door frame.

In this particular embodiment, the invention comprises a clip, generally indicated at 28. This clip is adapted to be selectively attached to the lower marginal end portion of the jamb.

As best shown in FIG. 2, the clip has a somewhat channel-shaped transverse cross-section including an upper horizontal flange portion 29, a dependent web 30, another horizontal flange portion 31 that terminates in a marginal end portion 32 having an upwardly-facing recess 33 into which the lower marginal end portion of jamb 10 is received. The lower marginal end portion of the flange may be frictionally held within recess 33. A bolt 34 is threaded into engagement with tapped holes provided in flange portions 29 and 31, and may be selectively rotated to adjust the vertical height of the clip and jamb relative to the floor. This device is particularly advantageous in that the clip may be retrofitted to existing jambs.

Second Form (FIGS. 3-4)

FIGS. 3 and 4 show another embodiment of the improved device. Here again, the device is shown in association with the jamb of a hollow door frame. Since this member has been previously described, a detailed description thereof will be omitted in the interest of clarity, it being understood that the same reference numerals referred to previously-described structure.

In this second form, the clip, generally indicated at 35, is in the form of a channel-shaped member having upper and lower flanges 36, 38 separated by a vertical web 39. In this embodiment, the right marginal portions of the flanges are suitably secured, as by weldments, indicated at 40, to the inner surface of the jamb. Here again, the device includes a bolt 34 that matingly engages two tapped holes provided in the web. While this arrangement is permanently attached, the clip may be readily tack-welded to existing door frames prior to their installation.

In both forms, the function of the improved device is to provide structure which allows the vertical portion of the jamb relative to the floor to be readily adjusted by selective rotation of bolt 34 relative to the associated clip. Thus, the traditional means for anchoring the hollow doorjamb to the supporting structure, namely drywall screws, may be selectively removed, and the position of the jamb may then be adjusted relative to the floor. Thereafter, the existing drywall screws may be inserted or reinserted, as the case may be. Should there be subsequent need to adjust the vertical position of the jamb, the drywall screws may be removed, and the position of member 34 may be selectively rotated relative to the associated clip to vary the vertical height of the jamb relative to the floor.

Modifications

The present invention contemplates that many changes and modifications may be made. For example, the materials of construction are not deemed to be particular critical. Similarly, the clips may have forms other than those shown. The threaded member may simply be a bolt, or some other member that matingly engages the jamb, and is used to adjust its vertical height relative to the floor.

Therefore, while two presently-preferred forms of the improved device have been shown and described, and several modifications thereof discussed, persons skilled in this art will readily appreciate that various additional changes may be made without departing from the spirit of the invention, as defined and differentiated by the following claims.

What is claimed is:

1. In a hollow door frame having a jamb that is adapted to be attached to supporting structure, the improvement comprising:
a clip adapted to be selectively attached to said jamb, said clip having at least one tapped hole; and
a threaded member matingly received in said tapped hole, said threaded member having a head portion adapted to engage the floor, and
wherein said threaded member may be selectively rotated relative to said clip to vary the vertical position of said jamb relative to said floor.

2. The improvement as set forth in claim 1 wherein said clip is adapted to be removably attached to said jamb.

3. The improvement as set forth in claim 1 wherein said clip has a recess adapted to embrace a portion of said jamb.

4. The improvement as set forth in claim 3 wherein said recess is adapted to embrace a lower marginal end portion of said jamb.

5. The improvement as set forth in claim 3 wherein said recess is recess is adapted to frictionally engage said jamb portion.

6. The improvement as set forth in claim 1 wherein said clip includes a channel-shaped portion having a web and two parallel flanges, and wherein aligned tapped holes are provided in said flanges to receive and accommodate said threaded member.

7. The improvement as set forth in claim 1 wherein said threaded member is a bolt.

8. In a hollow door fame having a jamb that is adapted to be attached to supporting structure, the improvement comprising:
a member attached to said jamb, said member having at least one tapped hole; and
a threaded member matingly received in said tapped hole, said threaded member having a head portion adapted to engage the floor; and
wherein said threaded member may be selectively rotated relative to said clip to vary the vertical position of said jamb relative to said floor.

9. The improvement as set forth in claim 8 wherein said member is permanently attached to said jamb.

10. The improvement as set forth in claim 9 wherein said member is welded to said jamb.

11. The improvement as set forth in claim 8 wherein said member is a channel-shaped member having a web and two parallel flanges, and wherein said flanges are provided with aligned tapped holes to receive and accommodate said threaded member.

12. The improvement as set forth in claim 11 wherein said threaded member is a bolt.
